(19) United States
(12) Patent Application Publication
(10) Pub. No.: US 2020/0201442 A1
(43) Pub. Date: Jun. 25, 2020

(54) GESTURE OPERATION DEVICE AND GESTURE OPERATION METHOD

(71) Applicant: MITSUBISHI ELECTRIC CORPORATION, Tokyo (JP)

(72) Inventor: Takayoshi CHIKURI, Tokyo (JP)

(73) Assignee: MITSUBISHI ELECTRIC CORPORATION, Tokyo (JP)

(21) Appl. No.: 16/613,015

(22) PCT Filed: Jun. 21, 2017
(86) PCT No.: PCT/JP2017/022847

§ 371 Date: Nov. 12, 2019

(51) Int. Cl. G06F 3/01; G10L 15/22; G10L 15/18

(52) U.S. Cl. CPC G06F 3/017; G10L 2015/223; G10L 15/1815; G10L 15/22

(57) ABSTRACT

A gesture recognition result acquiring unit (2a) acquires a gesture recognition result indicating a recognized gesture from a gesture recognition device (11). A voice recognition result acquiring unit (2b) acquires a voice recognition result that is provided by voice recognition of an uttered voice and that indicates function information corresponding to an utterance intention from a voice recognition device (13). A control unit (2d) registers the gesture and the function information in a storage unit (2c) while bringing the gesture and the function information into correspondence with each other, by using the gesture recognition result acquired from the gesture recognition result acquiring unit (2a) and the voice recognition result acquired from the voice recognition result acquiring unit (2b).

### TECHNICAL FIELD

The present disclosure relates to a gesture operation device that outputs function information indicating a function assigned to a recognized gesture.

### BACKGROUND ART

In recent years, gesture operation devices for operating various pieces of equipment by using a gesture have begun to spread. Gesture operation devices recognize a gesture of a user, and output function information indicating a function assigned to the recognized gesture to equipment that performs the function. Using such a gesture operation device, a user causes audio equipment to play back a piece of music next to another piece of music currently being played back, by, for example, moving his or her hand from left to right. In gesture operation devices, the correspondences as mentioned above between gestures and functions to be performed are registered. There is a case in which a user wants to newly register the correspondence between a gesture and a function to be performed in accordance with his or her preference.

For example, in Patent Literature 1, a mobile terminal device is described that includes: a touch panel having multiple segment areas; a pattern storage means for storing a registration pattern, which is formed by multiple adjacent segment areas of the touch panel, and a function while bringing the registration pattern and the function into correspondence with each other; and a pattern recognizing means for recognizing, as an input pattern, multiple segment areas that a user has touched continuously. When an input pattern which does not match the registration pattern is provided, the mobile terminal device stores the input pattern and a selected function while bringing the input pattern and the selected function into correspondence with each other, the selected function being selected in accordance with the user's operational input.

### CITATION LIST

### Patent Literature

Patent Literature 1: Japanese Patent No. 5767106

### SUMMARY OF INVENTION

### Technical Problem

In the mobile terminal device of above-mentioned Patent Literature 1, the user needs to select a function that the user wants the device to store while bringing the function into correspondence with a new registration pattern, by performing a manual operation using the touch panel or the like. Therefore, when the user does not know a procedure of selecting the function through a manual operation, it takes much time and effort to perform the registering operation.

The present disclosure is made in order to solve the above-mentioned problem, and it is therefore an object of the present disclosure to provide a gesture operation device that makes it possible to register a correspondence between a gesture and function information indicating a function to be performed in accordance with the gesture with less time and effort than if the correspondence is registered through a manual operation.

### Solution to Problem

A gesture operation device according to the present disclosure outputs function information indicating a function assigned to a recognized gesture, and includes: a gesture recognition result acquiring unit for acquiring a gesture recognition result indicating a recognized gesture; a voice recognition result acquiring unit for acquiring a voice recognition result that is provided by voice recognition of an uttered voice and that indicates function information corresponding to an utterance intention; and a control unit for registering the gesture indicated by the gesture recognition result acquired by the gesture recognition result acquiring unit, and the function information indicated by the voice recognition result acquired by the voice recognition result acquiring unit while bringing the gesture and the function information into correspondence with each other.

### Advantageous Effects of Invention

According to the present disclosure, the gesture indicated by the gesture recognition result acquired by the gesture recognition result acquiring unit, and the function information indicated by the voice recognition result acquired by the voice recognition result acquiring unit are registered while the gesture and the function information are brought into correspondence with each other, so that the correspondence between the gesture and the function information can be registered with less time and effort than if the correspondence is registered through a manual operation.

### BRIEF DESCRIPTION OF DRAWINGS

FIG. 1 is a block diagram showing a gesture operation device according to Embodiment 1 and components therearound;

FIG. 2 is a diagram showing an example of the correspondences between gestures and pieces of function information;

FIGS. 3A and 3B are diagrams each showing an example of the hardware configuration of the gesture operation device according to Embodiment 1;

FIGS. 4A and 4B are flow charts showing the operations of the gesture operation device in a performing state;

FIG. 5 is a flowchart showing the operation of the gesture operation device in a registering state;

FIG. 6 is a diagram showing an example of the correspondences between gestures and pieces of function information;

FIG. 7 is a block diagram showing a variant of the gesture operation device according to Embodiment 1; and

FIG. 8 is a block diagram showing a gesture operation device according to Embodiment 2 and components therearound.

### DESCRIPTION OF EMBODIMENTS

Hereinafter, in order to explain the present disclosure in greater detail, embodiments of the present disclosure will be described with reference to the accompanying drawings.

### Embodiment 1

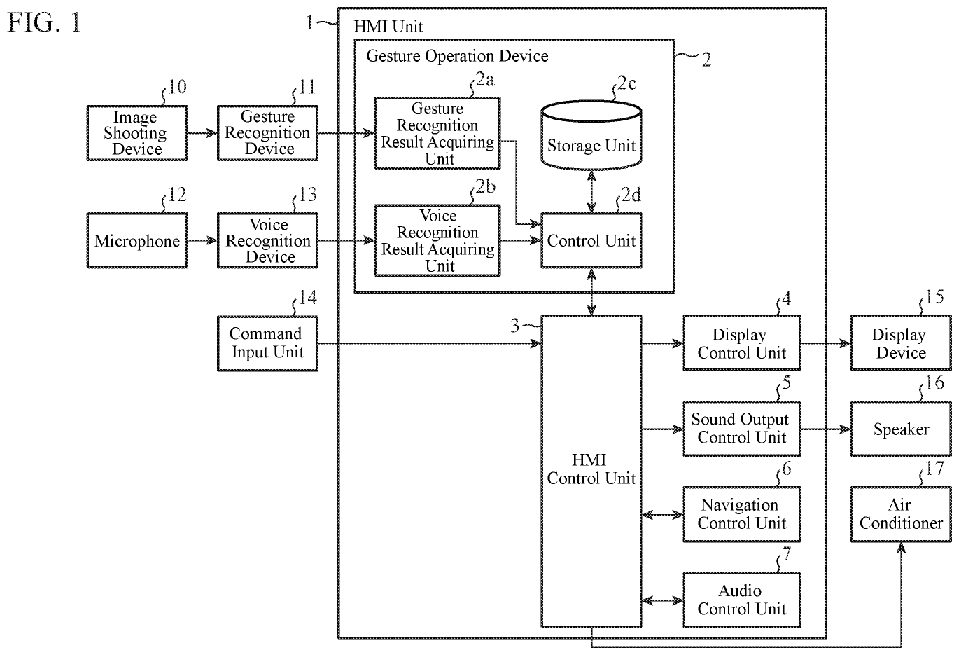

FIG. 1 is a block diagram showing a gesture operation device 2 according to Embodiment 1 and components therearound. The gesture operation device 2 is built in a human machine interface (HMI) unit 1. In Embodiment 1, a case in which the HMI unit 1 is mounted in a vehicle will be explained as an example.

The HMI unit 1 has a function of controlling vehicle-mounted equipment such as an air conditioner 17, a navigation function, an audio function, and so on.

Concretely, the HMI unit 1 acquires a voice recognition result that is a result of, in a voice recognition device 13, recognizing an uttered voice of an occupant, a gesture recognition result that is a result of, in a gesture recognition device 11, recognizing a gesture of the occupant, an operation signal outputted by a command input unit 14, and so on. Then, the HMI unit 1 performs processing in accordance with the voice recognition result, the gesture recognition result, and the operation signal that are acquired. For example, the HMI unit 1 outputs a command signal to vehicle-mounted equipment, more specifically for example, outputs, to the air conditioner 17, a command signal for commanding the air conditioner 17 to start air conditioning. Further, for example, the HMI unit 1 outputs, to a display device 15, a command signal for commanding the display device 15 to display an image. Further, for example, the HMI unit 1 outputs, to a speaker 16, a command signal for commanding the speaker 16 to output a sound.

An “occupant” is a person in the vehicle in which the HMI unit 1 is mounted. An “occupant” is also a user of the gesture operation device 2 or the like. Further, a “gesture of an occupant” is a gesture that an occupant has made in the vehicle, and an “uttered voice of an occupant” is a voice that an occupant has uttered in the vehicle.

Next, an overview of the gesture operation device 2 will be explained.

The gesture operation device 2 has, as its operating states, two different operating states: a performing state and a registering state. The performing state is a state in which control to perform a function corresponding to a gesture of an occupant is performed. The registering state is a state in which control to assign a function to a gesture of an occupant is performed. In Embodiment 1, the default operating state is the performing state, and an occupant is allowed to operate the command input unit 14 to issue a command to switch the operating state, thereby causing the operating state to be switched from the performing state to the registering state.

When the operating state is the performing state, the gesture operation device 2 acquires a gesture recognition result that is a result of recognizing a gesture of an occupant from the gesture recognition device 11, and performs control in such a way that the function assigned to the gesture is performed.

In contrast, when the operating state is the registering state, in addition to acquiring a gesture recognition result that is a result of recognizing a gesture of an occupant from the gesture recognition device 11, the gesture operation device 2 acquires a voice recognition result that is a result of recognizing an uttered voice of the occupant from the voice recognition device 13. Then, the gesture operation device 2 assigns a function based on the voice recognition result to the gesture. More specifically, when the operating state is the registering state, the gesture operation device 2 registers, as an operation intention of a gesture of an occupant, an intention of which the occupant has notified the gesture operation device 2 by giving utterance.

When the gesture operation device 2 is in the registering state, an occupant can cause the gesture operation device 2 to assign a function to a gesture, by making the gesture and also giving utterance to provide a notification of the operation intention of the gesture. Therefore, it is possible to perform registration with less time and effort than if an occupant operates the command input unit 14 to select and register a function that the occupant wants to assign to a gesture. Further, an occupant can intuitively perform an equipment operation in which a gesture is used because the occupant can freely determine a function to be assigned to a gesture in accordance with his or her preference.

Next, components shown in FIG. 1 will be explained in detail.

The gesture recognition device 11 acquires a shot image from an image shooting device 10 that shoots an image of the inside of the vehicle, and that is an infrared camera or the like. The gesture recognition device 11 analyzes the shot image to recognize a gesture of an occupant, and generates a gesture recognition result indicating the gesture and outputs the gesture recognition result to the gesture operation device 2. As gestures that the gesture recognition device 11 defines as targets for recognition, one or more types of gestures are predetermined, and the gesture recognition device 11 has pieces of information about the predetermined gestures. Therefore, a gesture of an occupant that the gesture recognition device 11 has recognized is a gesture whose corresponding type of gesture has been identified out of the predetermined gestures, and, in this regard, the same goes for the gesture indicated by the gesture recognition result. Because the recognition of a gesture using an analysis of a shot image is a known technique, an explanation of the recognizing technique will be omitted hereinafter.

The voice recognition device 13 acquires an uttered voice of an occupant from a microphone 12 provided in the vehicle. The voice recognition device 13 performs a voice recognition process on the uttered voice to generate a voice recognition result, and outputs the voice recognition result to the gesture operation device 2. At least function information corresponding to the occupant's utterance intention is indicated in the voice recognition result. Function information indicates a function to be performed by the HMI unit 1, the air conditioner 17, or the like. In addition, information acquired by converting the occupant's uttered voice into a text just as it is, and so on may be indicated in the voice recognition result. Because a technique of recognizing an utterance intention from an uttered voice and thereby specifying a function that is desired, by an occupant, to be performed is a known technique, an explanation of the technique will be omitted hereinafter.

The command input unit 14 receives an manual operation performed by an occupant, and outputs an operation signal corresponding to the manual operation to an HMI control unit 3. The command input unit 14 may be hardware keys such as buttons, or may be software keys such as a touch panel. Further, the command input unit 14 may be provided integrally in a steering wheel or the like, or may be provided singly as a device.

The HMI control unit 3 outputs a command signal to vehicle-mounted equipment such as the air conditioner 17, a navigation control unit 6 and an audio control unit 7 which will be mentioned later, or the like in accordance with the operation signal outputted by the command input unit 14 or function information outputted by the gesture operation device 2. The HMI control unit 3 also outputs image information outputted by the navigation control unit 6 to a display control unit 4 mentioned later. The HMI control unit 3 further outputs sound information outputted by the navigation control unit 6 or the audio control unit 7 to a sound output control unit 5 mentioned later.

The display control unit 4 outputs, to the display device 15, a command signal for causing the display device 15 to display an image indicated by the image information outputted by the HMI control unit 3. The display device 15 is, for example, a head up display (HUD) or a center information display (CID).

The sound output control unit 5 outputs, to the speaker 16, a command signal for causing the speaker 16 to output a sound indicated by the sound information outputted by the HMI control unit 3.

The navigation control unit 6 performs well-known navigation processing corresponding to the command signal outputted by the HMI control unit 3. For example, the navigation control unit 6 performs various searches, such as a facility search and an address search, using map data. The navigation control unit 6 also calculates a route to an destination that an occupant has set up using the command input unit 14. The navigation control unit 6 generates image information or sound information indicating a processing result, and outputs the image information or sound information to the HMI control unit 3.

The audio control unit 7 performs sound processing corresponding to the command signal outputted by the HMI control unit 3. For example, the audio control unit 7 performs a process of playing back a piece of music stored in a not-illustrated storage unit to generate sound information, and outputs the sound information to the HMI control unit 3. The audio control unit 7 also processes a radio broadcast wave to generate sound information of radio, and outputs the sound information to the HMI control unit 3.

The gesture operation device 2 has a gesture recognition result acquiring unit 2a, a voice recognition result acquiring unit 2b, a storage unit 2c, and a control unit 2d.

The gesture recognition result acquiring unit 2a acquires a gesture recognition result indicating a recognized gesture from the gesture recognition device 11. The gesture recognition result acquiring unit 2a outputs the acquired gesture recognition result to the control unit 2d.

The voice recognition result acquiring unit 2b acquires a voice recognition result that is provided by voice recognition of an uttered voice and that indicates function information corresponding to an utterance intention from the voice recognition device 13. The voice recognition result acquiring unit 2b outputs the acquired voice recognition result to the control unit 2d.

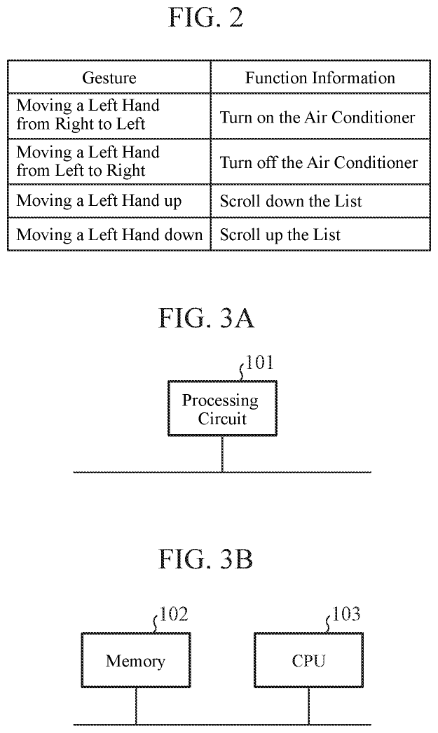

The storage unit 2c stores gestures that are targets for recognition in the gesture recognition device 11 and pieces of function information each indicating a function to be performed in accordance with a gesture, the gestures and the pieces of function information being brought into correspondence with each other. For example, as shown in FIG. 2, function information “turn on the air conditioner” for starting the air conditioner 17 is brought into correspondence with a gesture of “moving a left hand from right to left.” With each gesture that is a target for recognition in the gesture recognition device 11, certain function information is brought into correspondence as an initial setting in advance.

The control unit 2d has, as its operating states, the two different operating states: the performing state and the registering state.

When the operating state is the performing state, the control unit 2d performs both a process on a gesture recognition result acquired from the gesture recognition result acquiring unit 2a and a process on a voice recognition result acquired from the voice recognition result acquiring unit 2b in such a way that the processes are independent of each other.

Concretely, when acquiring a gesture recognition result from the gesture recognition result acquiring unit 2a, the control unit 2d refers to the storage unit 2c and thereby outputs the function information brought into correspondence with the gesture indicated by the gesture recognition result to the HMI control unit 3. On the other hand, when acquiring a voice recognition result from the voice recognition result acquiring unit 2b, the control unit 2d outputs the function information indicated by the voice recognition result to the HMI control unit 3.

Further, when the operating state is the registering state, the control unit 2d registers a gesture and function information in the storage unit 2c while bringing the gesture and the function information into correspondence with each other, by using a gesture recognition result acquired from the gesture recognition result acquiring unit 2a and a voice recognition result acquired from the voice recognition result acquiring unit 2b. In this registering process, when certain function information is already brought into correspondence with each gesture in advance, registration in overwrite mode is performed.

Concretely, when the operating state is switched to the registering state, the control unit 2d tries to acquire both a gesture recognition result and a voice recognition result until the control unit 2d completes the acquisition of both a gesture recognition result and a voice recognition result or until a registration enabled period mentioned later elapses. When then acquiring both a gesture recognition result and a voice recognition result, the control unit 2d registers the gesture indicated by the gesture recognition result and the function information indicated by the voice recognition result in the storage unit 2c while bringing the gesture and the function information into correspondence with each other. After that, the control unit 2d switches the operating state to the performing state.

In the control unit 2d, the registration enabled period that is a time period during which an occupant can register the correspondence between a gesture and function information is set up in advance. When the registration enabled period elapses after the operating state has been switched from the performing state to the registering state, the control unit 2d discards an acquired gesture recognition result or an acquired voice recognition result and switches the operating state from the registering state to the performing state. The registration enabled period may be able to be changed by an occupant.

In Embodiment 1, the default operating state of the control unit 2d is the performing state. When an occupant operates the command input unit 14 to issue a command to switch the operating state from the performing state to the registering state, an operation signal indicating the command is outputted to the control unit 2d via the HMI control unit 3, and the operating state of the control unit 2d is thereby switched to the registering state.

Next, examples of the hardware configuration of the gesture operation device 2 will be explained using FIGS. 3A and 3B.

The storage unit 2c of the gesture operation device 2 is constituted by one of various types of storage devices such as a memory 102 mentioned later.

Each of the functions of the gesture recognition result acquiring unit 2a, the voice recognition result acquiring unit 2b, and the control unit 2d of the gesture operation device 2 is implemented by a processing circuit. The processing circuit may be hardware for exclusive use, or a central processing unit (CPU) that executes a program stored in a memory. The CPU is also referred to as a central processing device, a processing device, an arithmetic device, a microprocessor, a microcomputer, a processor, or a digital signal processor (DSP).

FIG. 3A is a diagram showing an example of the hardware configuration in a case in which the functions of the gesture recognition result acquiring unit 2a, the voice recognition result acquiring unit 2b, and the control unit 2d are implemented by a processing circuit 101 that is hardware for exclusive use. The processing circuit 101 is, for example, a single circuit, a composite circuit, a programmable processor, a parallel programmable processor, an application specific integrated circuit (ASIC), a field programmable gate array (FPGA), or a combination of two or more thereof. The functions of the gesture recognition result acquiring unit 2a, the voice recognition result acquiring unit 2b, and the control unit 2d may be implemented by a combination of separate processing circuits 101, or the functions of the units may be implemented by a single processing circuit 101.

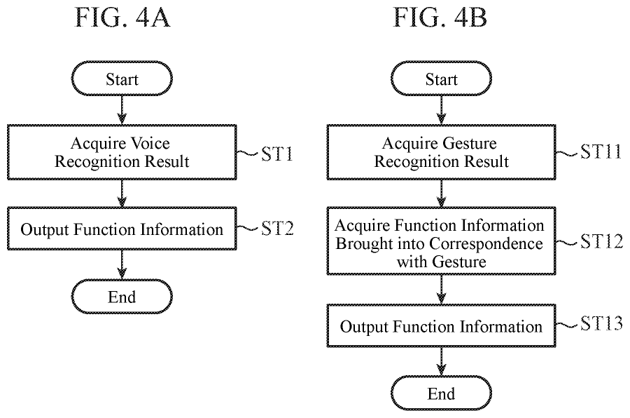

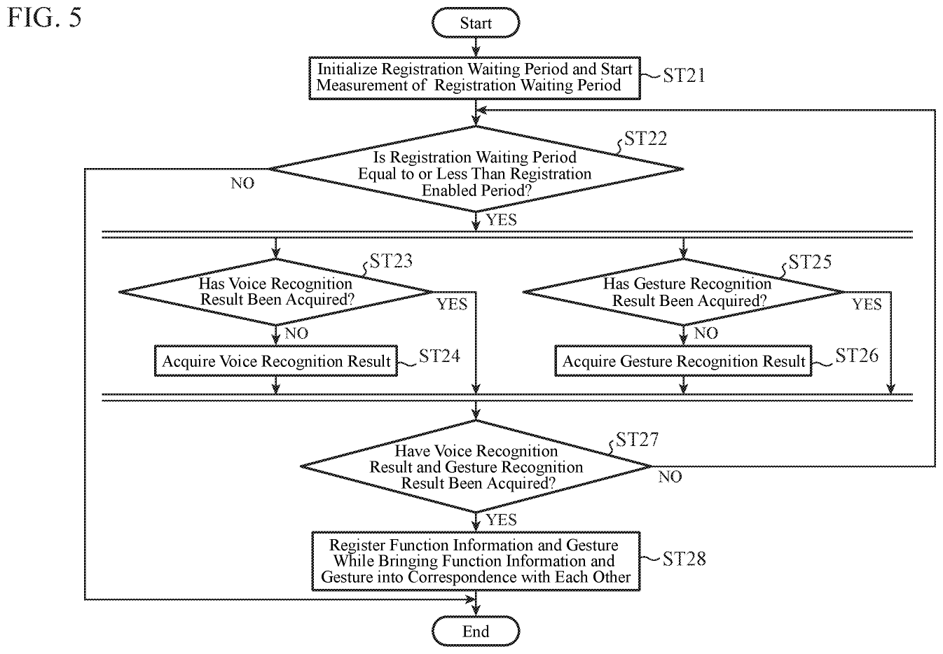

FIG. 3B is a diagram showing an example of the hardware configuration in a case in which the functions of the gesture recognition result acquiring unit 2a, the voice recognition result acquiring unit 2b, and the control unit 2d are implemented by a CPU 103 that executes programs stored in the memory 102. In this case, the functions of the gesture recognition result acquiring unit 2a, the voice recognition result acquiring unit 2b, and the control unit 2d are implemented by software, firmware, or a combination of software and firmware. Software and firmware are described as programs and the programs are stored in the memory 102. The CPU 103 implements the functions of the gesture recognition result acquiring unit 2a, the voice recognition result acquiring unit 2b, and the control unit 2d by reading and executing the programs stored in the memory 102. More specifically, the gesture operation device 2 has the memory 102 for storing the programs or the likes by which steps ST1 to ST28 shown in flow charts of FIGS. 4A, 4B, and 5 which will be mentioned later are performed as a result. Further, it can be said that these programs cause a computer to execute procedures or methods that the gesture recognition result acquiring unit 2a, the voice recognition result acquiring unit 2b, and the control unit 2d use. Here, the memory 102 is, for example, a non-volatile or volatile semiconductor memory, such as a random access memory (RAM), a read only memory (ROM), a flash memory, an erasable programmable ROM (EPROM), and an electrically erasable programmable ROM (EEPROM), or a disc-shaped recording medium, such as a magnetic disc, a flexible disc, an optical disc, a compact disc, a mini disc, and a digital versatile disc (DVD).

Apart of the functions of the gesture recognition result acquiring unit 2a, the voice recognition result acquiring unit 2b, and the control unit 2d may be implemented by hardware for exclusive use, and another part of the functions may be implemented by software or firmware. For example, the functions of the gesture recognition result acquiring unit 2a and the voice recognition result acquiring unit 2b can be implemented by a processing circuit as hardware for exclusive use, and the function of the control unit 2d can be implemented by a processing circuit's reading and execution of a program stored in a memory.

In this way, the processing circuit can implement the functions of the gesture recognition result acquiring unit 2a, the voice recognition result acquiring unit 2b, and the control unit 2d which are mentioned above, by using hardware, software, firmware, or a combination of two or more of hardware, software, and firmware.

The HMI control unit 3, the display control unit 4, the sound output control unit 5, the navigation control unit 6, the audio control unit 7, the gesture recognition device 11, and the voice recognition device 13 can also be implemented by the processing circuit 101 shown in FIG. 3A or the memory 102 and the CPU 103 which are shown in FIG. 3B, like the gesture operation device 2.

Next, operations of the gesture operation device 2 configured as above will be explained using the flow charts shown in FIGS. 4A, 4B, and 5. First, an operation when the operating state of the control unit 2d is the performing state will be explained using each of the flow charts shown in FIGS. 4A and 4B.

The flow chart of FIG. 4A shows an operation when an occupant utters words and the voice recognition result acquiring unit 2b acquires a voice recognition result and outputs the voice recognition result to the control unit 2d.

The control unit 2d acquires the voice recognition result outputted by the voice recognition result acquiring unit 2b (step ST1).

Next, the control unit 2d outputs the function information indicated by the acquired voice recognition result to the HMI control unit 3 (step ST2).

For example, when an occupant utters “Turn on the air conditioner”, the voice recognition device 13 outputs a voice recognition result indicating the function information “turn on the air conditioner” to the gesture operation device 2. Next, the voice recognition result acquiring unit 2b acquires the voice recognition result and outputs the voice recognition result to the control unit 2d. The control unit 2d outputs the function information indicated by the voice recognition result to the HMI control unit 3. The HMI control unit 3 outputs, to the air conditioner 17, a command signal for commanding the air conditioner 17 to start in accordance with the function information “turn on the air conditioner” outputted by the control unit 2d. In response to the command signal, the air conditioner 17 starts.

The flow chart of FIG. 4B shows an operation when an occupant makes a gesture and the gesture recognition result acquiring unit 2a acquires a gesture recognition result and outputs the gesture recognition result to the control unit 2d.

The control unit 2d acquires the gesture recognition result outputted by the gesture recognition result acquiring unit 2a (step ST11).

Next, the control unit 2d acquires the function information brought into correspondence with the gesture indicated by the gesture recognition result by referring to the storage unit 2c (step ST12).

The control unit 2d then outputs the acquired function information to the HMI control unit 3 (step ST13).

For example, when an occupant moves his or her left hand from right to left, the gesture recognition device 11 outputs a gesture recognition result indicating the gesture of “moving a left hand from right to left” to the gesture recognition result acquiring unit 2a. Next, the gesture recognition result acquiring unit 2a outputs the acquired gesture recognition result to the control unit 2d. The control unit 2d refers to the storage unit 2c and thereby acquires the function information brought into correspondence with the gesture of “moving a left hand from right to left” indicated by the gesture recognition result. In the case of the example of FIG. 2, the control unit 2d acquires “turn on the air conditioner.” The control unit 2d outputs the acquired function information to the HMI control unit 3. The HMI control unit 3 outputs, to the air conditioner 17, a command signal for commanding the air conditioner 17 to start in accordance with the function information “turn on the air conditioner” outputted by the control unit 2d. In response to the command signal, the air conditioner 17 starts.

The flow chart of FIG. 5 shows an operation when the operating state of the control unit 2d is the registering state. More specifically, an operation when the operating state of the control unit 2d is switched from the performing state to the registering state in response to a command issued by an occupant is shown in FIG. 5.

First, the control unit 2d initializes a registration waiting period, and starts a measurement of the registration waiting period (step ST21). The registration waiting period is a period that elapses after the operating state of the control unit 2d has been switched from the performing state to the registering state.

Next, the control unit 2d determines whether the registration waiting period is equal to or less than the registration enabled period (step ST22).

When the registration waiting period exceeds the registration enabled period (NO in step ST22), the control unit 2d switches the operating state from the registering state to the performing state and ends the processing in the registering state.

In contrast, when the registration waiting period is equal to or less than the registration enabled period (YES in step ST22), the control unit 2d performs the acquisition of a voice recognition result and the acquisition of a gesture recognition result in parallel.

Concretely, the control unit 2d determines whether the control unit 2d has acquired a voice recognition result (step ST23). When having not acquired a voice recognition result (NO in step ST23), the control unit 2d tries to acquire a voice recognition result from the voice recognition result acquiring unit 2b (step ST24), and, after that, performs a process of step ST27.

In contrast, when having acquired a voice recognition result (YES in step ST23), the control unit 2d performs the process of step ST27.

In parallel with the processes of steps ST23 and ST24, the control unit 2d determines whether the control unit 2d has acquired a gesture recognition result (step ST25). When having not acquired a gesture recognition result (NO in step ST25), the control unit 2d tries to acquire a gesture recognition result from the gesture recognition result acquiring unit 2a (step ST26), and, after that, performs the process of step ST27.

In contrast, when having acquired a gesture recognition result (YES in step ST25), the control unit 2d performs the process of step ST27.

Next, the control unit 2d determines whether the control unit 2d has acquired both a voice recognition result and a gesture recognition result (step ST27). When having not acquired at least one of a voice recognition result and a gesture recognition result (NO in step ST27), the control unit 2d performs the process of step ST22 again.

In contrast, when having acquired both a voice recognition result and a gesture recognition result (YES in step ST27), the control unit 2d registers the function information indicated by the voice recognition result and the gesture indicated by the gesture recognition result in the storage unit 2c while bringing the function information and the gesture into correspondence with each other (step ST28).

After step ST28, the control unit 2d switches the operating state from the registering state to the performing state and ends the processing in the registering state, like in the case in which it is determined in step ST22 that the registration waiting period exceeds the registration enabled period (NO in step ST22).

Hereinafter, a case in which an occupant wants to perform registration in such a way as to be able to start a radio by making a gesture of “moving a left hand from right to left” will be explained as an example.

After switching the operating state of the control unit 2d from the performing state to the registering state, the occupant moves his or her left hand from right to left within the registration enabled period while uttering “I would like to listen to the radio.”

The voice recognition device 13 performs a voice recognition process on the uttered voice “I would like to listen to the radio.” The voice recognition device 13 then outputs, to the voice recognition result acquiring unit 2b, a voice recognition result indicating “turn on the radio” that is the function information corresponding to “start the radio” that is the occupant's utterance intention. The control unit 2d acquires the voice recognition result via the voice recognition result acquiring unit 2b (steps ST23 and ST24).

Further, the gesture recognition device 11 analyzes a shot image acquired from the image shooting device 10, and thereby outputs a gesture recognition result indicating the gesture of “moving a left hand from right to left” to the gesture recognition result acquiring unit 2a. The control unit 2d acquires the gesture recognition result via the gesture recognition result acquiring unit 2a (steps ST25 and ST26).

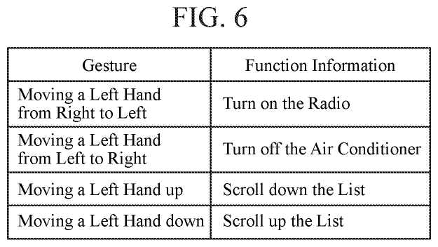

Then, the control unit 2d overwrites the function information registered in the storage unit 2c and corresponding to the gesture of “moving a left hand from right to left”, as shown in FIG. 2, to change the function information from “turn on the air conditioner” to “turn on the radio” and thereby register this new function information, for example. The correspondences between gestures and pieces of function information registered in the storage unit 2c after the overwriting are shown in FIG. 6. After that, the control unit 2d switches the operating state from the registering state to the performing state and ends the processing in the registering state.

As a result, it becomes possible for the occupant to start the radio after that by moving his or her left hand from right to left.

As mentioned above, the gesture operation device 2 according to Embodiment 1 registers the gesture indicated by a gesture recognition result and the function information indicated by a voice recognition result, i.e., the utterance intention of an occupant while bringing the gesture and the function information into correspondence with each other.

An occupant can provide a notification of the operation intention of a gesture for the gesture operation device 2, i.e., register the function information corresponding to the gesture, by giving utterance that is a means different from manual operations. Therefore, an occupant can perform registration with less time and effort than if the occupant notifies the gesture operation device 2 of the operation intention of a gesture through a manual operation.

Further, because an occupant can determine the correspondences between gestures and pieces of function information in accordance with his or her preference, the occupant can intuitively perform an equipment operation in which a gesture is used.

Further, an occupant is enabled, by the gesture operation device 2 according to Embodiment 1 that uses a voice recognition result acquired from the voice recognition device 13, to notify the gesture operation device 2 of a complicated intention as the operation intention of a gesture, and register the complicated intention, i.e., function information while bringing the function information into correspondence with the gesture.

For example, an occupant switches the operating state of the gesture operation device 2 to the registering state, and makes a gesture of “moving his or her left hand from right to left” within the registration enabled period while uttering “Create an e-mail “I'm on my way back now.” This enables the occupant to register multiple functions including a function of “displaying an e-mail creation screen” and a function of “inputting “I'm on my way back now” as the e-mail text” while bringing the multiple functions into correspondence with the gesture, by giving utterance once.

Even though an occupant knows a method of creating an e-mail through a manual operation, the occupant spends much time and effort on creating an e-mail because the occupant needs to input characters as a mail text after performing multiple manual operations in order to cause a mail creation screen to be displayed. In contrast with this, because the gesture operation device 2 according to Embodiment 1 uses a voice recognition result acquired from the voice recognition device 13, an occupant can register multiple functions for a single gesture by giving utterance once. As a result, because users can create an e-mail “I'm on my way back now” only by performing an intuitive gesture operation, the time and effort required for creation of the e-mail is less than that for creating the e-mail through a manual operation.

In addition to registering function information while bringing the function information into correspondence with a gesture of an occupant, the gesture operation device 2 may automatically register other function information that pairs up with the function information for another gesture that pairs up with the gesture of the occupant.

In this case, as to each gesture that is a target for recognition in the gesture recognition device 11, another gesture that pairs up with the gesture is stored in advance in the storage unit 2c for the purpose of reference by the control unit 2d. Further, in the storage unit 2c, as to each piece of function information, another piece of function information that pairs up with the function information is stored in advance.

Then, when registering first function information indicated by an acquired voice recognition result in the storage unit 2c while bringing the first function information into correspondence with a first gesture indicated by an acquired gesture recognition result, the control unit 2d specifies second function information that pairs up with the first gesture and a second gesture that pairs up with the first gesture.

Next, the control unit 2d overwrites the function information brought into correspondence with the second gesture in the storage unit 2c with the specified second function information, to register the second function information.

For example, when the function information “turn on the radio” is registered by an occupant while being brought into correspondence with a gesture of “moving a left hand from right to left”, the control unit 2d automatically registers other function information “turn off the radio” that pairs up with the function information “turn on the radio” while bringing the function information “turn off the radio” into correspondence with another gesture of “moving a left hand from left to right” that pairs up with the gesture of “moving a left hand from right to left.”

Further, in the above-mentioned case, the gesture operation device 2 acquires a voice recognition result from the voice recognition device 13 even when the operating state is the performing state. At this time, the HMI control unit 3 acquires function information via the gesture operation device 2. However, the gesture operation device 2 may be configured in such a way as to not acquire a voice recognition result from the voice recognition device 13 when the operating state is the performing state. In this case, the HMI control unit 3 acquires a voice recognition result directly from the voice recognition device 13 and recognizes the function information indicated by the voice recognition result. In FIG. 1, an illustration of a connecting line needed when the HMI control unit 3 acquires a voice recognition result directly from the voice recognition device 13 is omitted.

Concretely, when the operating state is the performing state, the control unit 2d commands the voice recognition result acquiring unit 2b not to acquire a voice recognition result from the voice recognition device 13. Further, the HMI control unit 3 switches the control of itself in such a way as to acquire a voice recognition result directly from the voice recognition device 13. Then, when the operating state is switched to the registering state, the control unit 2d commands the voice recognition result acquiring unit 2b to acquire a voice recognition result from the voice recognition device 13. Further, the HMI control unit 3 switches the control of itself in such a way as to acquire function information via the gesture operation device 2.

Further, in the above-mentioned gesture operation device 2, the registration enabled period is provided, and, as long as the registration enabled period does not elapse, a gesture and function information are registered while the gesture and the function information are brought into correspondence with each other even though the gesture and utterance are provided at different times. However, registering a gesture and function information while bringing the gesture and the function information into correspondence with each other may be performed only when the gesture and utterance are provided at nearly the same time. Further, when the registration enabled period is provided, a rule for the order of performing a gesture and utterance may be present or may be absent.

Further, when the operating state is the registering state, the gesture operation device 2 may perform control in such a way that the types of gestures that the gesture recognition device 11 can recognize are displayed on the display device 15. Concretely, pieces of image information about gestures that the gesture recognition device 11 can recognize are stored in the storage unit 2c, and the control unit 2d outputs the pieces of image information to the HMI control unit 3 when the operating state is switched to the registering state.

In this case, it is not necessary for occupants to read a manual or the like even though they do not know gestures which are allowed to be used for registration. Thus, the convenience is enhanced.

Further, the correspondences between gestures and pieces of function information may be registered on a person by person basis. In this case, for example, the gesture recognition device 11 or the voice recognition device 13 functions as a personal identification device that identifies a person. The gesture recognition device 11 can identify a person by means of face authentication or the like, using a shot image acquired from the image shooting device 10. Further, the voice recognition device 13 can identify a person by means of voiceprint authentication or the like, using an uttered voice acquired from the microphone 12. The personal identification device outputs an identification result indicating an identified person to the gesture operation device 2.

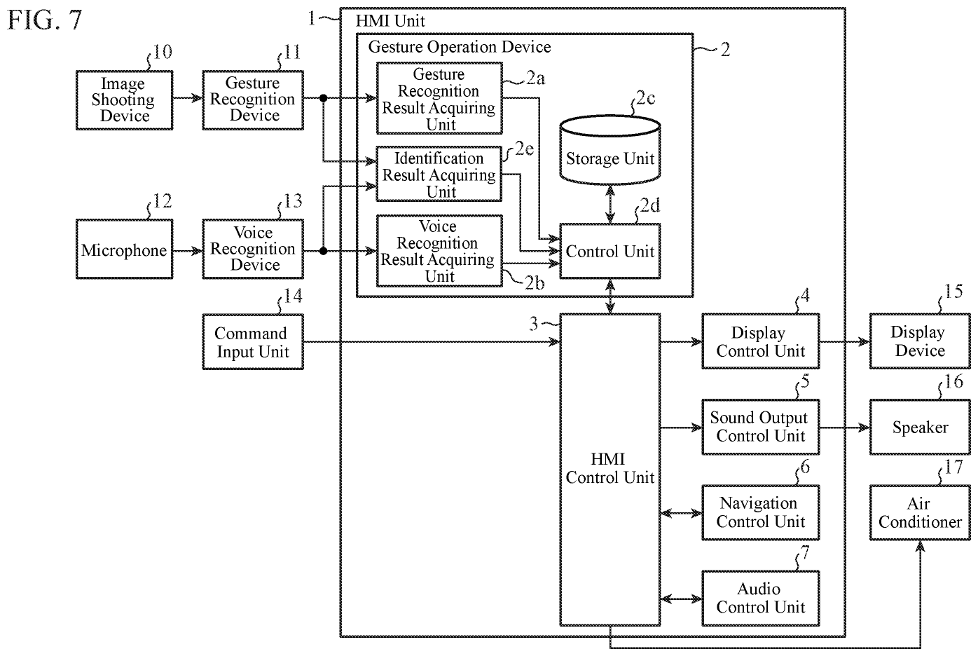

The gesture operation device 2 has an identification result acquiring unit 2e that acquires the identification result, as shown in FIG. 7, and the identification result acquiring unit 2e outputs the acquired identification result to the control unit 2d.

When acquiring both a gesture recognition result and a voice recognition result in the registering state, the control unit 2d registers the gesture indicated by the gesture recognition result and the function information indicated by the voice recognition result on a person by person basis while bringing the gesture and the function information into correspondence with each other, by using the identification result. As a result, for example, the function information brought into correspondence with the gesture of “moving a left hand from right to left” is defined as “turn on the radio” for a user A, while the function information is defined as “turn on the air conditioner” for a user B.

When then acquiring a gesture recognition result in the performing state, the control unit 2d specifies, for the person indicated by the identification result, the function information brought into correspondence with the gesture indicated by the gesture recognition result. As a result, for example, when the user A makes a gesture of “moving his or her left hand from right to left”, the radio starts, whereas when the user B makes the same gesture, the air conditioner starts.

As described above, the correspondences between gestures and pieces of function information are registered on a person by person basis, and the convenience is thereby improved.

Further, the example in which the above-mentioned gesture operation device 2 is mounted in a vehicle and is used in order for occupants to operate pieces of equipment in the vehicle is explained above. However, the gesture operation device 2 can be used in order for users to operate not only pieces of equipment in a vehicle but also various pieces of equipment. For example, the gesture operation device 2 may be used in order for users to operate electric appliances in a residence by making a gesture. Users of the gesture operation device 2 and the like in this case are not limited to occupants in a vehicle.

### Embodiment 2

In Embodiment 2, an embodiment in a case in which multiple persons may exist in an image shooting area captured by an image shooting device 10 will be explained. In this case, a gesture operation device 2 performs processing on a gesture of a person who has uttered words in a registering state. More specifically, when, for example, an occupant in the front seat in a vehicle wants to register a gesture and function information while bringing the gesture and the function information into correspondence with each other, and then utters words, the gesture operation device 2 uses the gesture of the occupant in the front seat for a registering process. This prevents a gesture of another occupant in the driver's seat performed before a gesture of the occupant in the front seat from causing registration different from registration that the occupant in the front seat intends.

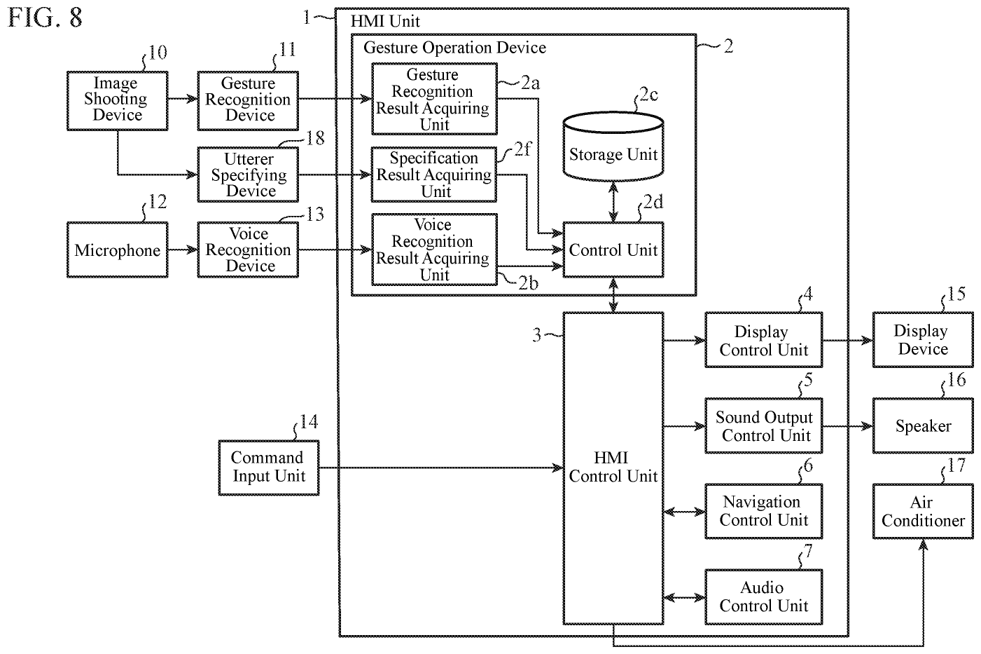

FIG. 8 is a block diagram showing the gesture operation device 2 according to Embodiment 2 and components therearound. Also in Embodiment 2, a case in which the gesture operation device 2 is mounted in a vehicle will be explained as an example. Further, components having functions that are the same as or equivalent to those of the components already explained in Embodiment 1 are denoted by the same reference signs, and an explanation of each component will be omitted or simplified as appropriate.

The image shooting device 10 is a camera provided in, for example, a central portion of a dashboard and having an angle of view which allows the image shooting area to include the driver's seat and the front seat. The image shooting device 10 outputs a generated shot image to an utterer specifying device 18, in addition to outputting the shot image to a gesture recognition device 11.

The gesture recognition device 11 analyzes the shot image acquired from the image shooting device 10, and thereby recognizes a gesture of an occupant in the driver's seat and a gesture of an occupant in the front seat. The gesture recognition device 11 then generates a gesture recognition result indicating the correspondences between the recognized gestures and the persons who have made the gestures, and outputs the gesture recognition result to the gesture operation device 2.

The utterer specifying device 18 analyzes the shot image acquired from the image shooting device 10, to specify which one of the occupant in the driver's seat and the occupant in the front seat has uttered words. A known technique such as a method of specifying an utterer on the basis of mouth opening and closing motions may be used as a method of specifying an utterer by using a shot image, and an explanation of the specifying method will be omitted hereinafter. The utterer specifying device 18 generates a specification result indicating the specified utterer and outputs the specification result to the gesture operation device 2.

A specification result acquiring unit 2f acquires the specification result from the utterer specifying device 18, and outputs the specification result to a control unit 2d. The utterer specifying device 18 and the specification result acquiring unit 2f can be implemented by the processing circuit 101 shown in FIG. 3A, or the memory 102 and the CPU 103 which are shown in FIG. 3B.

The specification of an utterer is performed in accordance with a command from the control unit 2d. More specifically, when acquiring a voice recognition result from a voice recognition result acquiring unit 2b in the registering state, the control unit 2d commands the specification result acquiring unit 2f to acquire a specification result from the utterer specifying device 18. Then, the specification result acquiring unit 2f commands the utterer specifying device 18 to output a specification result.

The utterer specifying device 18 holds images that have been shot for a past set time period by using a not-illustrated storage unit, and specifies an utterer in response to the command from the specification result acquiring unit 2f.

When acquiring a specification result from the specification result acquiring unit 2f, the control unit 2d recognizes the utterer's gesture by using the specification result and a gesture recognition result acquired from a gesture recognition result acquiring unit 2a. The control unit 2d then registers the utterer's gesture and the function information indicated by the voice recognition result acquired from the voice recognition result acquiring unit 2b in a storage unit 2c, while bringing the utterer's gesture and the function information into correspondence with each other. For example, when the specification result indicates that the occupant in the driver's seat is an utterer, the control unit 2d registers the gesture of the occupant in the driver's seat, the gesture being indicated by the gesture recognition result, and the function information indicated by the voice recognition result in the storage unit 2c, while bringing the gesture and the function information into correspondence with each other.

In this way, by using the gesture recognition result and the specification result, the control unit 2d registers the utterer's gesture while properly bringing the utterer's gesture into correspondence with the function information indicated by the voice recognition result acquired by the voice recognition result acquiring unit 2b.

As mentioned above, the gesture operation device 2 according to Embodiment 2 registers a gesture of an utterer while bringing the gesture into correspondence with the function information indicated by a voice recognition result, even when gestures of multiple persons are recognized. Therefore, the gesture operation device 2 according to Embodiment 2 can prevent a gesture that an utterer does not intend from being registered, in addition to providing the same advantages as Embodiment 1.

Although the above explanation is made using a case in which the image shooting area captured by the image shooting device 10 includes the driver's seat and the front seat, the image shooting area may be a wider area further including a rear seat.

Further, it is to be understood that any combination of the embodiments can be made, various changes can be made in any component according to the embodiments, and any component according to the embodiments can be omitted within the scope of the present disclosure.

### INDUSTRIAL APPLICABILITY

As mentioned above, because the gesture operation device according to the present disclosure makes it possible to register a correspondence between a gesture and function information with less time and effort than if the correspondence is registered through a manual operation, the gesture operation device is suitable for use as, for example, a device mounted in a vehicle and used for operating equipment in the vehicle.

### REFERENCE SIGNS LIST

1 HMI unit, 2 gesture operation device, 2a gesture recognition result acquiring unit, 2b voice recognition result acquiring unit, 2c storage unit, 2d control unit, 2e identification result acquiring unit, 2f specification result acquiring unit, 3 HMI control unit, 4 display control unit, 5 sound output control unit, 6 navigation control unit, 7 audio control unit, 10 image shooting device, 11 gesture recognition device, 12 microphone, 13 voice recognition device, 14 command input unit, 15 display device, 16 speaker, 17 air conditioner, 18 utterer specifying device, 101 processing circuit, 102 memory, and 103 CPU.

1. A gesture operation device that outputs function information indicating a function assigned to a recognized gesture, the gesture operation device comprising:
processing circuitry
to acquire a gesture recognition result indicating a recognized gesture;
to acquire a voice recognition result that is provided by voice recognition of an uttered voice and that indicates function information corresponding to an utterance intention; and
to register the gesture indicated by the gesture recognition result acquired, and the function information indicated by the voice recognition result acquired while bringing the gesture and the function information into correspondence with each other.

2. The gesture operation device according to claim 1, wherein the processing circuitry has a registering state and a performing state as operating states, and
when an operating state is the registering state, the processing circuitry registers the gesture indicated by the gesture recognition result acquired, and the function information indicated by the voice recognition result acquired while bringing the gesture and the function information into correspondence with each other, whereas when the operating state is the performing state, the processing circuitry outputs function information brought into correspondence with the gesture indicated by the gesture recognition result acquired.

3. The gesture operation device according to claim 1, wherein when registering a first gesture and first function information while bringing the first gesture and the first function information into correspondence with each other, the processing circuitry registers second function information that pairs up with the first function information while bringing the second function information into correspondence with a second gesture that pairs up with the first gesture.

4. The gesture operation device according to claim 2, wherein the processing circuitry registers a gesture indicated by a gesture recognition result that is acquired within a registration enabled period after the operating state has been set to the registering state, and function information indicated by a voice recognition result that is acquired within the registration enabled period after the operating state has been set to the registering state while bringing the gesture and the function information into correspondence with each other.

5. The gesture operation device according to claim 1, wherein the processing circuitry acquires an identification result indicating an identified person, and
the processing circuitry registers the gesture indicated by the gesture recognition result acquired, and the function information indicated by the voice recognition result acquired on a person by person basis while bringing the gesture and the function information into correspondence with each other, by using the identification result acquired.

6. The gesture operation device according to claim 1, wherein the processing circuitry acquires a specification result indicating a specified utterer,
the processing circuitry acquires a gesture recognition result indicating a correspondence between a recognized gesture and a person who has made the gesture, and
the processing circuitry registers a gesture of the utterer while bringing the gesture of the utterer into correspondence with the function information indicated by the voice recognition result acquired, by using the gesture recognition result indicating the correspondence and the specification result acquired.

7. A gesture operation method for a gesture operation device that outputs function information indicating a function assigned to a recognized gesture, the method comprising:
acquiring a gesture recognition result indicating a recognized gesture;
acquiring a voice recognition result that is provided by voice recognition of an uttered voice and that indicates function information corresponding to an utterance intention; and
registering the gesture indicated by the gesture recognition result acquired, and the function information indicated by the voice recognition result acquired while bringing the gesture and the function information into correspondence with each other.
